(19) United States
(12) Patent Application Publication
(10) Pub. No.: US 2013/0243922 A1
(43) Pub. Date: Sep. 19, 2013

(54) REMOVAL OF ALCOHOL FROM POTABLE LIQUID USING VACUUM EXTRACTION

(71) Applicants: Judd B. Lynn, Murrieta, CA (US); Kelli Lynn Fuller, Murrieta, CA (US)

(72) Inventors: Judd B. Lynn, Murrieta, CA (US); Kelli Lynn Fuller, Murrieta, CA (US)

(21) Appl. No.: 13/804,260

(22) Filed: Mar. 14, 2013

Related U.S. Application Data
(60) Provisional application No. 61/612,542, filed on Mar. 19, 2012.

(51) Int. Cl. C12G 3/08

(52) U.S. Cl. CPC C12G 3/08
USPC 426/494; 202/205

(57) ABSTRACT

Certain embodiments provide apparatuses and methods for removing alcohol from alcoholic beverages. In certain embodiments, the apparatus includes a vessel, a fluid conduit configured to be inserted into a beverage, the fluid conduit configured to allow the beverage to flow into the vessel, a heating system comprising a distribution surface within the vessel, the distribution surface configured to receive the beverage and to heat the beverage, and a vacuum system configured to apply a vacuum to the beverage while the beverage is heated by the distribution surface. In certain embodiments, the method includes using the apparatuses described herein to reduce the alcohol content of an alcoholic beverage.

### CROSS-REFERENCE TO RELATED APPLICATIONS

This application claims the benefit of priority to U.S. Provisional Appl. No. 61/612,542, filed on Mar. 19, 2012 and incorporated in its entirety by reference herein.

### BACKGROUND

1. Field of the Application

The present application relates generally to systems and methods for the removal of alcohol from alcoholic beverages.

2. Description of the Related Art

Currently, manufacturers provide a wide variety of different alcoholic beverages to consumers. Based on the availability of this variety, consumers acquire preferences for particular alcoholic wines and beers based on their aroma, taste, structure, texture and balance. Despite there being a great variety of alcoholic beverages available to the consumer, the choice of alcohol-free, or dealcoholized, beverages is limited to the few brands and flavors manufacturers are willing to produce. Thus, when a consumer seeks a non-alcoholic alternative to an alcoholic beverage, their choices are limited. This limitation creates a demand for a wider variety of nonalcoholic beverages that have the same variety of flavor as their alcoholic alternatives.

Further, commercial dealcoholizing of beverages uses large scale processing. Because of the equipment and time requirements of large scale processes to remove alcohol from beverages, consumers cannot use this method at home to prepare their own non-alcoholic beverages. Large scale processing systems and methods used to remove alcohol from alcoholic beverages include vacuum distillation, pervaporation, and reverse osmosis. These systems have not been amendable to use by the consumer because they are complicated or leave a product without a desirable taste profile. None of these methods are suitable for home preparation by a consumer.

### SUMMARY

Disclosed herein are systems (e.g., apparatuses) and methods for the preparation of reduced alcohol beverages. Certain embodiments provide an apparatus for removing alcohol from alcoholic beverages, wherein the apparatus comprises a vessel, a fluid conduit configured to be inserted into a beverage, the fluid conduit configured to allow the beverage to flow into the vessel, a heating system comprising a distribution surface within the vessel, the distribution surface configured to receive the beverage and to heat the beverage, and a vacuum system configured to apply a vacuum to the beverage while the beverage is heated by the distribution surface.

In certain embodiments, the heating system comprises a plurality of thermoelectric elements configured to heat the distribution surface in response to an electric current.

In certain embodiments, the apparatus further comprises a reservoir configured to contain the beverage, wherein the reservoir is in fluid communication with the vessel via the fluid conduit.

In certain embodiments, the fluid conduit is configured to allow vacuum to pull the beverage from the reservoir into the vessel. In certain embodiments, the fluid conduit is configured to be attached to and reversibly detached from the reservoir.

In certain embodiments, the heating system comprises a plate which comprises the distribution surface.

In certain embodiments, the heating system comprises a thermoelectric assembly and electrical connectors configured to allow electrical power to be applied to the thermoelectric assembly, wherein a first side of the thermoelectric assembly is configured to provide heat to the distribution surface upon electrical power being applied to the thermoelectric assembly, and a second side of the thermoelectric assembly configured to absorb heat from an inner surface of the vessel upon electrical power being applied to the thermoelectric assembly.

In certain embodiments, the apparatus further comprises at least one port to deliver the beverage received from the fluid conduit to a portion of the distribution surface. In certain embodiments, the at least one port is configured to disperse the beverage as a thin flow onto the distribution surface.

In certain embodiments, the fluid conduit is perforated along a length in proximity to the distribution surface to allow the beverage to be received by the distribution surface.

In certain embodiments, during operation, the distribution surface has an upper portion and a lower portion, wherein the beverage is received by the upper portion, wherein the distribution surface is configured such that the beverage is heated as the beverage travels from the upper portion to the lower portion of the distribution surface. In certain embodiments, when the beverage reaches the lower portion of the distribution surface it is collected in a collection reservoir. In certain embodiments, at least a portion of the collection reservoir is cooled.

In certain embodiments, the apparatus further comprises a reservoir configured to contain the beverage, wherein the reservoir is in fluid communication with the vessel via the fluid conduit, and a recycling conduit, wherein the recycling conduit is in fluid communication with the reservoir and the collection reservoir such that the contents of the collection reservoir can be transferred to the reservoir via the recycling conduit.

In certain embodiments, the distribution surface comprises one or more structures selected from the group consisting of: ridges, channels, troughs, conduits, indentations, protrusions, perforations, and additive layers. In certain embodiments, the distribution surface comprises at least one of a metallic mesh layer and a paper layer.

In certain embodiments, the apparatus further comprises an alcohol collection reservoir.

In certain embodiments, at least a portion of the vessel is in thermal communication with a cooling source that allows alcohol-containing distillate from the beverage to condense and flow to the alcohol collection reservoir. In certain embodiments, at least a portion of the vessel contains ice wherein the alcohol-containing distillate on the interior walls of the vessel flows into the ice thereby diluting the alcohol-containing distillate.

In certain embodiments, the apparatus further comprises a volatiles collection reservoir. In certain embodiments, at least a portion of the vessel is in thermal communication with a cooling source that allows volatiles from the beverage to condense and flow to the volatiles collection reservoir.

In certain embodiments, the vacuum source is controllable to apply a vacuum to the beverage wherein the pressure is controlled to between about 10.5″ Hg and about 11.5″ Hg, between about 10.5″ Hg and about 12.5″ Hg, between about 12.5″ Hg and about 14.5″ Hg, between about 14.5″ Hg and about 16.5″ Hg, between about 16.5″ Hg and about 18.5″ Hg, between about 18.5″ Hg and about 20.5″ Hg, between about 20.5″ Hg and about 22.5″ Hg, between about 22.5″ Hg and about 24.5″ Hg, between about 24.5″ Hg and about 26.5″ Hg, between about 26.5″ Hg and about 28.5″ Hg, or to between about 28.5″ Hg and about 30.0″ Hg.

In certain embodiments, the apparatus further comprises at least one sensor configured to monitor a temperature of the heated distribution surface, the beverage, or both.

In certain embodiments, the vessel is graduated.

In certain embodiments, the vacuum system comprises a vacuum pump and further comprises a matrix of chilled channels placed in a path of at least one of alcohol vapor and water vapor going to the vacuum pump, wherein the matrix of channels condenses the at least one alcohol vapor and water vapor.

Certain embodiments provide an apparatus for removing alcohol from alcoholic beverages, the apparatus comprising a vessel, a fluid conduit configured to be inserted into a beverage, the fluid conduit configured to allow the beverage to flow into the vessel, a distribution surface configured to receive the beverage and to be in thermal communication with the beverage, a heating element configured to heat the distribution surface, and a vacuum system configured to apply a vacuum to the beverage received by the distribution surface.

In certain embodiments, the distribution surface is cone-shaped, sheet-shaped, plate-shaped, fluted, ribbed, or channeled.

Certain embodiments provide a method for reducing the alcohol content of a beverage, the method comprising flowing the beverage along a portion of a distribution surface of a heating plate, applying heat to the beverage while the beverage flows along the portion of the distribution surface, applying vacuum to the beverage while the beverage flows along the portion of the distribution surface, and collecting the beverage after having flowed along the portion of the distribution surface.

In certain embodiments, the method involves collecting a beverage with an alcohol content in the range between about 0.01% to about 1%, about 1% to about 3%, from about 3% to about 5%, from about 5% to about 10%, or from about 10% to about 15%.

In certain embodiments, wherein the beverage has a first volume prior to flowing along the portion of the distribution surface, the method further comprises reconstituting the collected beverage to the original volume by adding water to the collected beverage.

In certain embodiments, the method further comprises cooling the collected beverage to less than 50° C. before the collected beverage is exposed to oxygen.

In certain embodiments, the method comprises applying heat to the beverage wherein the beverage is heated to less than 60° C.

In certain embodiments, the method comprises applying a pressure between about 21″ Hg and about 29″ Hg to the beverage.

### BRIEF DESCRIPTION OF THE DRAWINGS

Non-limiting and non-exhaustive embodiments are described herein with reference to the following figures, wherein like reference numerals refer to like parts throughout the various figures unless otherwise specified.

FIG. 1 depicts an example system for removing alcohol from alcoholic liquids in accordance with certain embodiments described herein.

FIG. 2 depicts another example system for removing alcohol from alcoholic liquids in accordance with certain embodiments described herein.

FIG. 3 depicts another example system for removing alcohol from alcoholic liquids in accordance with certain embodiments described herein.

### DETAILED DESCRIPTION

The present disclosure relates to devices, apparatuses, and methods for the removal of alcohol from alcoholic beverages. An unmet need currently exists for a small scale alcohol removing system that can be operated at home for individual users. Certain embodiments described herein involve the removal of alcohol from beverages at a scale that is practical for an individual or small scale consumer. In certain embodiments, the apparatus is sized to fit on a countertop. Certain embodiments described herein involve the use of small scale, controlled vacuum distillation systems to treat alcoholic beverages and to reduce their alcohol content while preserving their flavor.

A liquid will evaporate at lower temperature under reduced pressure (vacuum). In the case of a solution of more than one liquid components, each liquid component of the solution will have an accelerated evaporation rate as the vacuum is applied. Thus, the boiling point of a liquid is directly related to the pressure above the liquid. When boiling a mixture of liquids having different boiling points, generally, the components with lower boiling points will distill faster. Thus, when boiling a beaker of an aqueous alcohol solution, the relative concentration of alcohol in the vapor state generally exceeds the relative concentration of alcohol in the liquid state.

In certain embodiments described herein, the process of causing alcohol to evaporatively separate from a water-based solution such as wine, sake (“rice wine”), liquor, beer, and other alcoholic beverages, takes advantage of the different vapor pressures of water and alcohol. In a solution of water and alcohol, the temperature of the solution affects the vapor pressure of all the components of a solution being evaporated; the higher the temperature, the higher the vapor pressure. However, the change in vapor pressure of alcohol and water as a function of temperature is not linear. Under conditions in which alcohol has a higher vapor pressure than water, alcohol can be removed from an aqueous solution at a higher alcohol-to-water ratio than the aqueous solution itself.

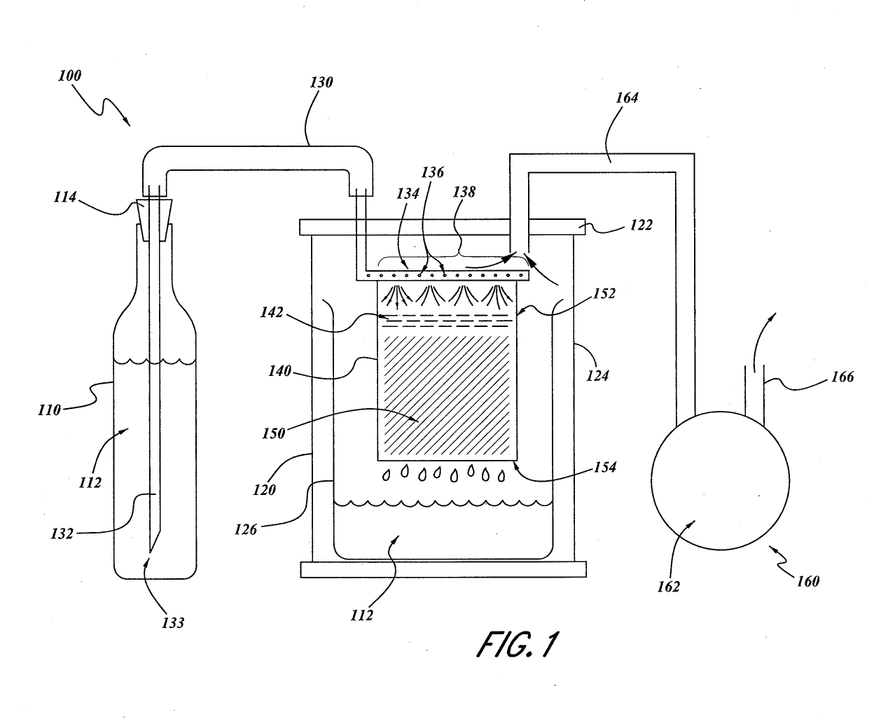

FIG. 1 depicts an example system 100 (e.g., an apparatus) for removing alcohol from an alcoholic liquid (e.g., an alcoholic beverage 112) in accordance with certain embodiments described herein. For example, the beverage 112 can be initially held in a reservoir 110 that is configured to hold the beverage 112. The system 100 comprises a vessel 120 and a fluid conduit 130 (e.g. one or more tubes) configured to be inserted into the beverage 112 and configured to allow the beverage 112 to flow into the vessel 120. The system 100 further comprises a heating system 140 comprising a distribution surface 150 within the vessel 120, wherein the distribution surface 150 is configured to receive the beverage 112 and to heat the beverage 112. The system 100 further comprises a vacuum system 160 configured to apply a vacuum to the beverage 112 while the beverage 112 is heated by the distribution surface 150.

In certain embodiments, the beverage 112 comprises wine, sake (“rice wine”), liquor, beer, or other alcoholic beverages. The reservoir 110 can comprise a container (e.g., bottle, can) in which the beverage 112 is contained during transport to the user and prior to removal of the alcohol. In certain embodiments, the reservoir 110 is a component of the system 100, while in other embodiments, the reservoir 110 is not a component of the system 100 but is separately provided. In certain embodiments, the reservoir 110 may comprise food safe plastic, glass, metal (e.g., stainless steel, aluminum, copper, etc.) or another suitable material for containing a beverage 112. In certain embodiments, the reservoir 110 comprises a material suitable for holding a reduced pressure (e.g., vacuum) from the surrounding environment.

In certain embodiments, the reservoir 110 is in fluidic communication with the vessel 120 via the fluid conduit 130. The fluid conduit 130 can comprise at least one tube, pipe, or channel having a fluid inlet 132 that is configured to be inserted into the beverage 112 and which can be configured to be inserted through a reservoir cap 114 (e.g., stopper, cork). For example, the fluid inlet 132 can comprise a lancet 133 that allows puncturing of the reservoir cap 114 (e.g., a vacuum-tight manner). In certain embodiments, the fluid conduit 130 extends from a depth of the beverage 112 through the reservoir cap 114 and through a vessel cap 122 of the vessel 120. In certain embodiments, the fluid conduit 130 is configured to allow the beverage 112 to flow from the reservoir 110 to the vessel 120.

In certain embodiments, the vessel 120 comprises a vessel cap 122 and a vessel body 124. In certain embodiments, the vessel cap 122 is configured to be reversibly and repeatedly coupled to the vessel body 124 to provide access to an inner region of the vessel 120. The vessel body 124 can be sized to contain at least a portion of the heating system 140 (e.g., the distribution surface 150). At least one of the vessel cap 122 and the vessel body 124 can comprise one or more ports configured to be in fluidic communication with the fluid conduit 130 and the vacuum system 160.

In certain embodiments, the vessel 120 is configured to be sealed against the entry of air (e.g., airtight and/or vacuum tight) from the surrounding atmosphere and configured to have its contents within an atmosphere substantially free of oxygen. For example, the vessel 120 can be configured to hold its contents (e.g., the distribution surface 150) at reduced pressure (e.g., in a vacuum produced by the vacuum system 160). As another example, the vessel 120 can be configured to hold its contents under a substantially inert atmosphere that is substantially free of oxygen (e.g., an atmosphere primarily comprising nitrogen and/or a noble gas).

In certain embodiments, the vessel 120 comprises a thermally conductive material (e.g. a metal, stainless steel, aluminum, copper, etc.) so that it can be heated and cooled quickly (e.g., in less than about 30 minutes, less than about 15 minutes, less than about 10 minutes, or less than about 5 minutes). The vessel 120 may also comprise food safe plastic, glass, or another suitable material for containing a beverage 112 and holding a reduced pressure (e.g., vacuum) from the surrounding environment.

In certain embodiments, the vessel 120 comprises a collection reservoir 126 (e.g., chamber, beaker, bottle, tank, container) configured to contain the beverage 112 after having at least some of its alcohol removed. The collection reservoir 126 may comprise food safe plastic, glass, ceramic, metal (e.g., stainless steel, aluminum, copper, etc.), low thermal conductivity material, or another suitable material for containing the beverage 112 that does not react with the beverage 112. The collection reservoir 126 can be placed such that the beverage 112, after having flowed across at least a portion of the distribution surface 150, flows or drips into the collection reservoir 126 (e.g., by force of gravity). The collection reservoir 126 can reside within the vessel 120 and can be configured to have its contents (e.g., the beverage 112 after having flowed across the portion of the distribution surface 150) exposed to the atmosphere substantially free of oxygen (e.g., in the vacuum or in the substantially inert atmosphere).

In certain embodiments, at least a portion of the vessel 120 and/or at least a portion of the collection reservoir 126 is cooled. For example, the system can comprise a cooling system in thermal communication with a portion of the vessel 120 and/or the collection reservoir 126. The cooling system can comprise one or more of the following: a refrigeration unit, thermoelectric elements, cold material (e.g., ice), or coolant (e.g. flowing through a cooling jacket) in thermal communication with the portion of the collection reservoir 126 and/or the vessel 120. In certain embodiments, the fluid conduit 130 is in fluidic communication with the distribution surface 150. The fluid conduit 130 can comprise a fluid outlet 134 proximal to the distribution surface 150 and comprising at least one port 136 configured to allow the beverage 112 to discharge onto the distribution surface 150 evenly (e.g., by spraying the beverage 112 onto the distribution surface 150). For example, the fluid outlet 134 can comprise an elongate distribution tube 138 in proximity to the distribution surface 150. In certain embodiments, the at least one port 136 of the distribution tube 138 (e.g., perforations in the distribution tube 138) can be configured to allow the beverage 112 to spray or flow out of the fluid outlet 134 with an even distribution of the beverage 112 onto the distribution surface 150. By having the beverage 112 released in a spray or thin flow, certain embodiments advantageously allow at least some of the alcohol to evaporate from the beverage 112 while the spray is in space or the flow is thin or essentially with minimal depth. In certain embodiments, the fluid conduit 130 is configured to be reversibly and repeatedly attached and detached from one or more reservoirs 110. In certain embodiments, the fluid conduit 130 comprises vacuum tubing (e.g., rubber), food safe plastic, glass, metal (e.g., stainless steel, aluminum, copper, etc.) or another suitable material for transferring the beverage 112 and holding reduced pressure (e.g., vacuum) relative to the surrounding environment.

In certain embodiments, the heating system 140 comprises the distribution surface 150 and is configured to provide thermal power to at least a portion of the distribution surface 150 for heating the beverage 112. For example, the heating system 140 can comprise one or more heating components 142 (e.g., resistive heating elements, thermoelectric devices, convective or radiative devices) in thermal communication with at least a portion of the distribution surface 150, and can further comprise one or more electrical wires, feedthroughs, conduits, connectors, and power sources (not shown) configured to provide energy to the one or more heating components 142. For example, the heating components 142 can comprise a resistive heater rod comprising a heat conductive material (e.g., a metal such as stainless steel, copper, or aluminum) that runs the length of the distribution surface 150. In certain embodiments, the physical mass of the portion of the heating system 140 that undergoes temperature changes is advantageously minimized to shorten times for heating and for cooling the distribution surface 150.

The heating components 142 can be above the distribution surface 150 (e.g., positioned on the distribution surface 150). For example, the heating components 142 can be positioned across an upper portion 152 of the distribution surface 150. Alternatively, the heating components 142 can be below the distribution surface 150 (e.g., embedded within or mounted below a structure comprising the distribution surface 150). In certain embodiments, the one or more heating components 142 can be positioned such that the distribution surface 150 comprises one or more surfaces of the one or more heating components 142. The heated portion (e.g., the upper portion 152) of the distribution surface 150 can heat the beverage 112 as the beverage 112 is in thermal communication (e.g., contacts) the heated portion of the distribution surface 150.

In certain embodiments, the vacuum system 160 is in fluidic communication with the vessel 120 and is configured to pump out (e.g., evacuate) at least a portion of the atmosphere from within the vessel 120. For example, the vacuum system 160 can reduce the pressure within the vessel 120 such that the atmosphere remaining in the vessel 120 is substantially free of oxygen. In certain embodiments, the vacuum system 160 reduces the pressure within the vessel 120. This pressure reduction reduces the boiling temperature of the beverage allowing alcohol to be removed at a lower temperature. The vacuum system 160 can comprise a vacuum pump 162 (e.g., a mechanical pump, a turbomolecular pump, a peristaltic pump, an aspirator pump, a vane pump, a diaphragm pump) and a vacuum conduit 164 (e.g., at least one tube, pipe, or channel) which provides fluidic communication between the vacuum pump 162 and the vessel 120 which containing the distribution surface 140. In certain embodiments, the vacuum source 160 is configured to reduce the pressure in the vessel 120 and to remove alcohol vapor from within the vessel 120 (e.g., resulting from evaporation from the beverage 112 as it flows across at least a portion of the distribution surface 150). The reduced pressure within the vessel 120 can also draw the beverage 112 from the reservoir 110 through the fluid conduit 130 and to the distribution surface 150.

In certain embodiments, the alcohol vapor from the vessel 120 to the vacuum source 160 can be condensed on the inside walls of the vessel 120 (e.g. by cooling the vessel walls), can be exhausted into the atmosphere, or can be trapped in a condenser (e.g., by cooling the walls of the condenser). In certain embodiments, the vacuum system comprises an exhaust 166 (e.g., tube) that can be constructed to have multiple sequential stages of condensation and evaporation to cause the majority of water content in the evaporative vapor to condense (e.g., to be collected and returned to the beverage 112) and the majority of alcohol vapor to pass out of the system 100 and be exhausted to the atmosphere or be trapped in a condenser. In certain embodiments, the amount of alcohol water solution being evaporated is small at any one time, so the vacuum source 160 can be small capacity and portable, and can advantageously be more power efficient, quieter, smaller, and less costly than a large pump.

In certain embodiments, the distribution surface 150 comprises a surface of a structure (e.g., a plate) that is heated by the heating system 140. In certain embodiments, the structure comprising the distribution surface 150 comprises a sufficiently thermally conductive material to facilitate even (e.g., uniform) heat transfer from the heating components 142 to the distribution surface 150. In certain embodiments, the distribution surface 150 comprises a sufficiently thermally conductive material to facilitate even (e.g., uniform) heat transfer from the heating components 142 across the distribution surface 150. For example, the structure, heating components, and/or the distribution surface 150 can comprise a metal (e.g., stainless steel, aluminum, copper, etc.). In certain embodiments, the distribution surface 150 may be coated with plastic or glass.

In certain embodiments, the structure and distribution surface 150 are configured to reach operating temperatures quickly (e.g., in less than about 30 minutes, less than about 15 minutes, less than about 10 minutes, or less than about 5 minutes) and/or to cool to non-operating temperatures (e.g., room temperature) quickly (e.g., in less than about 30 minutes, less than about 15 minutes, less than about 10 minutes, or less than about 5 minutes).

The distribution surface 150 can be planar, sheet-shaped, plate-shaped, cone-shaped, funnel-shaped, fluted, curved, or angled, so as to facilitate flow of the beverage 112 across at least a portion of the distribution surface 150. When a liquid is dispensed on a surface, the liquid tends to form concentrations and flow in narrow rivulets. The evaporative function of the distribution surface 150 is enhanced by increasing the surface area of the beverage 112 (e.g., by having the beverage 112 flow in a broad thin film along the distribution surface 150), so in certain embodiments, the distribution surface 150 comprises features for improving fluid film distribution across the distribution surface 150. For example, the shape of the distribution surface 150 may be selected to maximize the surface area of the beverage 112 and the evaporation of alcohol from the beverage 112.

For example, the distribution surface 150 can comprise one or more structures (e.g., ridges, channels, troughs, conduits, indentations, protrusions, perforations, additive layers, surface treatments, or other structures configured to modify the surface tension between the beverage 112 and the distribution surface 150) configured to keep the beverage 112 evenly distributed across the portion of the distribution surface 150 as the beverage 112 flows across the portion of the distribution surface 150. In certain embodiments, the distribution surface 150 comprises a plurality of thin channel barriers (e.g., ridges, ribs) that prevent wide areas of the fluid film from coalescing into rivulets with less surface area. In certain other embodiments, the distribution surface 150 comprises a textured or mesh surface (e.g., a metallic mesh layer, a paper layer). The one or more structures of the distribution surface 150 can facilitate the beverage 112 having an increased surface area while the beverage 112 flows along at least the portion of the distribution surface 150, thereby facilitating heating of the beverage 112 as well as evaporation of alcohol from the beverage 112 as the beverage 112 flows along the portion of the distribution surface 150.

In certain embodiments, the one or more structures comprising the distribution surface 150 can be stacked. For example, the one or more structures may comprise stacks of discs and/or cones. In certain embodiments, the discs and/or cones may be arranged in a pyramidal formation so that as the beverage 112 is distributed on the one or more discs and/or cones at the top of the formation, the beverage 112 flows down onto the successive one or more discs and/or cones (e.g., in an even fashion). In certain embodiments, one or more structures comprise multiple cones oriented alternatively in both an upright (e.g., apex-up) and inverted (e.g., apex-down) such that the beverage 112 may be distributed and flow along an upright top cone and off an edge of the top cone onto a second level of inverted cones, flowing along the surfaces of the second level of inverted cones, and drain through holes onto the next upright cone, and so forth down the series of cones. In certain embodiments, the cones may be shallow (e.g., having a diameter with that is more than one time, five times, ten times, 15 times, 20 times, or 25 times greater than the height of the cone). In certain other embodiments, the cones are not shallow. In certain embodiments, the cones could be heated by a central rod heater. In certain embodiments, the one or more discs and/or cones are sufficiently thermally conductive to remain at a working temperature throughout their surface area (e.g. metal).

In certain embodiments, when the structure comprising the distribution surface 150 is plate-shaped, the plate has a width and a length, the dimensions of which can be independently selected. The length can be along the general direction of the beverage flow down the distribution surface 150. The length can be in the range from about 2″ to about 12″, about 2″ to about 3″, from about 3″ to about 4″, from about 4″ to about 5″, from about 5″ to about 6″, from about 6″ to about 7″, from about 7″ to about 8″, from about 8″ to about 9″, from about 9″ to about 10″, from about 10″ to about 11″, or from about 11″ to about 12″. The width of the plate can be generally perpendicular to the length (e.g., along the general direction across which the beverage 112 is distributed). The width can be in the range from about 2″ to about 10″, 2″ to about 3″, from about 3″ to about 4″, from about 4″ to about 5″, from about 5″ to about 6″, from about 6″ to about 7″, from about 7″ to about 8″, from about 8″ to about 9″, or from about 9″ to about 10″. By varying the plate length and angle, the exposure time of the beverage 112 to heat can be tailored. For example, the length of the plate can be used in conjunction with flow rate to achieve a desired time of evaporative exposure (e.g., a high flow rate down a long plate is an alternative for a low flow rate down a short plate).

In certain embodiments, the distribution surface 150 is oriented such that gravity forces the beverage 112 to flow across the portion of the distribution surface 150. In certain such embodiments, the distribution surface 150 has an upper portion 152 and a lower portion 154 such that the beverage 112 flows along (e.g., down) the distribution surface 150 from the upper portion 152 to the lower portion 154. In certain embodiments, when the distribution surface 150 is sheet-shaped, the distribution surface 150 may be held at a preset angle. For example, the angle of the distribution surface 150 relative to horizontal (e.g., a plane perpendicular to the direction of gravity) is between about 5° and about 10°, about 10° and about 20°, about 20° and about 30°, about 30° and about 40°, about 40° and about 50°, about 50° and about 60°, about 60° and about 70°, about 70° and about 80°, or from about 80° to about 85°.

In certain embodiments, the distribution surface 150 is configured to receive the beverage 112 (e.g., from the fluid conduit 130), to allow the beverage 112 to flow across at least a portion of the distribution surface 150, and to heat the beverage 112 as it flows across the portion of the distribution surface 150. For example, the beverage 112 emitted from the fluid outlet 134 of the fluid conduit 130 (e.g., the distribution tube 138) can contact or otherwise be received by a heated portion of the distribution surface 150 (e.g., the top portion 152 heated by the heating components 142), which heats the beverage 112 as it flows across the heated portion of the distribution surface 150. The heated beverage 112 can continue flowing across the distribution surface 150 until it reaches the lower portion 154 of the distribution surface 150, where the beverage 112 flows (e.g., drips) from the distribution surface 150 to the collection reservoir 126. As the heated beverage 112 flows across the distribution surface 150, it undergoes evaporation by which alcohol vaporizes from the beverage 112. The resulting alcohol vapors can be condensed on the inner walls of the vessel with the gaseous vapor being removed from the vessel 120 by the vacuum system 160.

In certain embodiments, exposing the beverage 112 heated by the distribution surface 150 to reduced pressure (e.g., produced by the vacuum system 160) allows alcohol to be removed from the beverage 112 as it flows over the distribution surface 150 at temperatures lower than would be needed for such evaporation at atmospheric pressure. In addition, exposing the beverage 112 heated by the distribution surface 150 to an atmosphere substantially free of oxygen allows alcohol to be removed from the beverage 112 without having the beverage 112 exposed concurrently to both oxygen and heightened temperatures, thereby avoiding undesirable oxidation of the beverage 112.

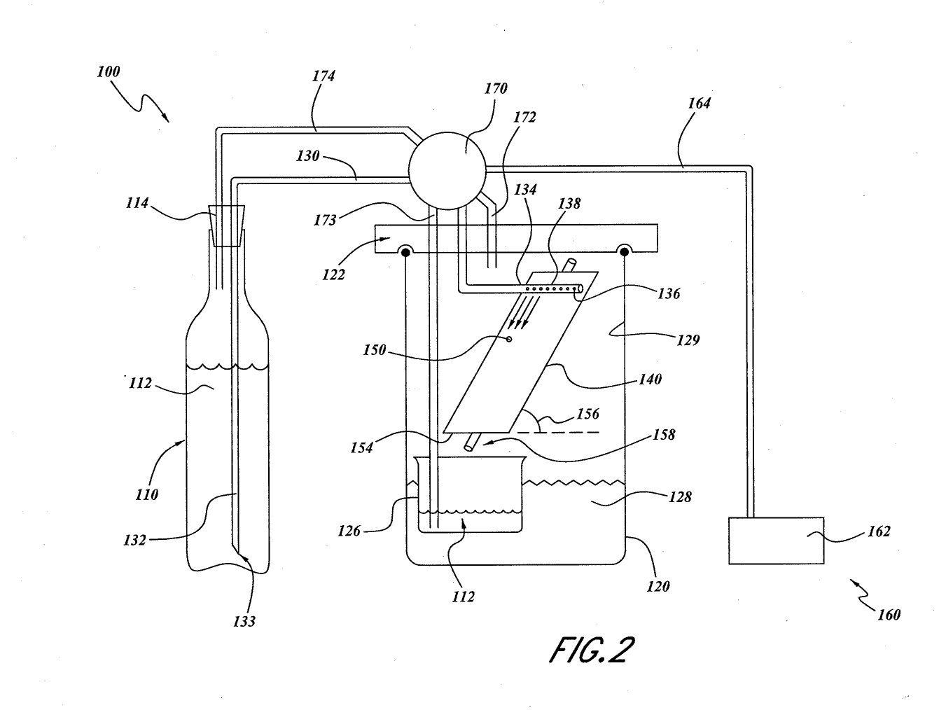

FIG. 2 depicts another example system 100 (e.g., an apparatus) for removing alcohol from an alcoholic liquid (e.g., an alcoholic beverage 112) in accordance with certain embodiments described herein. The beverage 112 can be initially held in a reservoir 110 that is configured to hold the beverage 112. The system 100 comprises a vessel 120 and a fluid conduit 130 (e.g. one or more tubes) configured to be inserted into the beverage 112 and configured to allow the beverage 112 to flow into the vessel 120. The system 100 further comprises a heating system 140 comprising a distribution surface 150 within the vessel 120, wherein the distribution surface 150 is configured to receive the beverage 112 and to heat the beverage 112. The system 100 further comprises a vacuum system 160 configured to apply a vacuum to the beverage 112 while the beverage 112 is heated by the distribution surface 150.

The distribution surface 150 schematically illustrated in FIG. 2 is oriented at an angle 156 relative to horizontal (shown in FIG. 2 by a dashed line)(e.g., a plane perpendicular to the direction of gravity). For example, the angle 156 can be between about 5° and about 10°, about 10° and about 20°, about 20° and about 30°, about 30° and about 40°, about 40° and about 50°, about 50° and about 60°, about 60° and about 70°, about 70° and about 80°, or from about 80° to about 85°. In certain embodiments, the distribution surface 150 is fixed at a predetermined angle 156 (e.g., the angle 156 is set during fabrication of the system 100), while in certain other embodiments, the angle of the distribution surface 150 can be adjusted (e.g., by the user just prior to or during use of the system 100). In certain embodiments, the angle 156 is such that the flow rate of the beverage 112 across the portion of the distribution surface 150 is at a predetermined value. For example, by increasing the angle 156 of the distribution surface 150 relative to horizontal, the flow rate of the beverage 112 across the portion of the distribution surface 150 can be increased. Control (e.g., selection) of the angle 156 (and thereby control or selection of the flow rate of the beverage 112 down the heated portion of the distribution surface 150) is one way of controlling (e.g. selecting) the amount of alcohol that is removed from the beverage 112. For example, by increasing the angle 156, the beverage 112 flows faster along the distribution surface 150, spends less time being heated by the distribution surface 150, and spends less time having an increased surface area conducive to evaporation of alcohol from the beverage 112. Thus increasing the angle 156 is expected to reduce the amount of alcohol removed from the beverage 112.

The collection reservoir 126 schematically illustrated in FIG. 2 is in thermal communication with an ice bath 128 (e.g., held in a chamber, beaker, bottle, tank, container) such that the collection reservoir 126 is cooled. In certain such embodiments, the beverage 112 within the collection reservoir 126 is also cooled such that its temperature is lower than its temperature while in thermal communication with the distribution surface 150). Other cooling mechanisms are also compatible with certain embodiments described herein, including but not limited to, refrigeration, thermoelectric elements, or coolant flowing through a cooling jacket in thermal communication with the collection reservoir 126. The cooling of the collected solution can advantageously reduce the re-evaporation of these fluids and helps keep the partial pressure in the vessel 120 low.

In certain embodiments, the collection reservoir 126 is shaped so that it has a deepest portion where the beverage 112 collects. In certain embodiments, a drain conduit can be inserted into this deepest portion and through which the accumulated beverage 112 (e.g., the beverage 112 after having some or all of its alcohol removed) may be retrieved.

In certain embodiments, the lower portion 154 of the distribution surface 150 comprises a drain conduit 158 through which the beverage 112 that reaches the lower portion 154 flows from the distribution surface 150. As shown in FIG. 2, the collection reservoir 126 can be positioned under the drain conduit 158 so that the collection reservoir 126 collects the reduced alcohol beverage 112 flowing (e.g., dripping) from the distribution surface 150.

In the example system 100 of FIG. 2, the evaporating portion of the beverage 112 absorbs heat from the distribution surface 150, and this heat is replaced by the heating components 142 (e.g., electrical resistive heater). As the evaporated vapor condenses on the interior walls 129 of the vessel 120, that heat is released into the walls 129. As a result, the interior vessel walls 129 then become coated with a high percentage alcohol liquid condensate and are warmed. This warming can cause the condensate to evaporate from the walls 129 and that evaporation tends to raise the partial pressure in the vessel 120. This elevation of the partial pressure in the vessel 120 can slow the evaporation from the beverage 112 flowing along the distribution surface 150. As the vessel wall temperature increases and the evaporation of the wall condensate accelerates, and the partial pressure in the vessel 120 rises, the original evaporation from the distribution surface 150 can stop, or “stall” and the process of separating the alcohol from the beverage 112 stops.

To counteract this result, it can be advantageous to cool the interior walls 129 of the vessel 120 (e.g., using ice or other cooling method). For example, in the example system 100 of FIG. 2, the interior walls 129 of the vessel 120 are also cooled by the ice bath 128 placed in the bottom of the vessel 120 in the vacuum atmosphere and the vessel walls can be highly thermally conductive, thus chilling the entire vessel 120. The interior walls 129 can comprise a thermally conductive material (e.g., a metal such as stainless steel, copper, aluminum, etc. which can be anodized or having a glass enamel coating) and can have a non-stick coating. The cooled interior walls 129 facilitate condensation of the alcohol vapor removed from the beverage 112, and this readily condensed liquid remains cool and non-evaporative. Thus, the cooling of the walls 129 can advantageously reduce the re-evaporation of the condensed fluids and helps keep the partial pressure in the vessel 120 low. Because, in certain such embodiments, the vessel 120 contains ice or uses other cooling methods, it may be advantageous to cover the exterior of the vessel 120 with a thermally insulating material to help keep the walls 129 from absorbing heat from the outside ambient environment.

In certain embodiments, the condensed alcohol on the interior walls 129 flows into the ice bath 128 or another region within the vessel 120. For example, the condensate can run down the walls 129 into a diluting bath (e.g., the ice bath 128) in the bottom of the vessel 120 (e.g., as shown in FIG. 2). By having the condensed alcohol flow into and diluted by the ice bath 128 (or another volume of liquid such as water), the alcohol can advantageously be collected in a diluted form. In certain embodiments, the condensed vapors that gather on the interior walls 129 can flow downward and be intercepted by one or more ports (e.g., channels) that allow the condensates to flow to one or more separate collection vessels internal or external to the vessel 120.

In certain embodiments, it may be desirable to ensure that the condensates are diluted by having the diluting bath comprise a float switch configured to ensure that the diluting bath contains sufficient liquid for diluting the condensate. For example, the float switch can be monitored by the process control system to allow the process to begin (e.g., allow a vacuum to be applied to the beverage 112) only when the diluting bath contains more than a predetermined amount of liquid (e.g., 750 ml).

The heating system 140 of the system 100 schematically illustrated in FIG. 2 comprises heating components 142 that are attached to a back portion of the structure comprising the distribution surface 150 (e.g., the opposite side of the structure relative to the distribution surface 150 across which the beverage 112 flows). In certain embodiments, the heating components 142 apply heat to the entire distribution surface 150. For example, as the beverage 112 flows along (e.g., down) the distribution surface 150, the beverage 112 is continuously heated by the heating system 140. Certain such embodiments advantageously maintain an elevated temperature of the beverage 112 as it flows along the distribution surface 150, counteracting the cooling of the beverage 112 that occurs by virtue of the evaporation of the alcohol from the beverage 112.

In certain embodiments, the system 100 further comprises a selector valve assembly 170 (e.g., one or more fixed or adjustable metering valves) that is in fluidic communication with the vessel 120, the fluid conduit 130, and the vacuum system 160. In certain embodiments, the selector valve assembly 170 is controlled manually and/or electronically and can independently control the vacuum pressure of the vessel 120 (e.g., by controllably opening and closing the fluidic communication between the vessel 120 and the vacuum system 160) and the amount and flow rate of the beverage 112 that flows from the reservoir 110 into the vessel 120 (e.g., by controllably opening and closing the fluidic communication between the vessel 120 and the fluid conduit 130). For example, the selector valve assembly 170 provides a valve between the vacuum conduit 162 and a conduit 172 providing fluidic communication to the vessel 120, such that the selector valve assembly 170 can control the fluidic communication between the vacuum conduit 162 and the conduit 172. For another example, the selector valve assembly 170 provides a valve between a portion of the fluid conduit 130 and the vessel 120, such that the selector valve assembly 170 can control the fluidic communication between the vessel 120 and the reservoir 110.

In certain embodiments, the selector valve assembly 170 is configured to allow recycling of the beverage 112 by allowing the transfer of the beverage 112 (after having flowed along the distribution surface 150) back to the reservoir 110 via the recycling conduits 173, 174. For example, the selector valve assembly 170 can be configured to allow the beverage 112 to be transferred out of the reservoir 110 into the fluid conduit 130 by the vacuum in the vessel 120, where it eventually accumulates in the collection reservoir 126. Subsequently, the selector valve assembly 170 can be configured (e.g., by the user or automatically) to transfer the collected (non-alcoholic) beverage 112 from the collection reservoir 126 (e.g., via the recycling conduits 173, 174) back to the reservoir 110 (e.g., the original container).

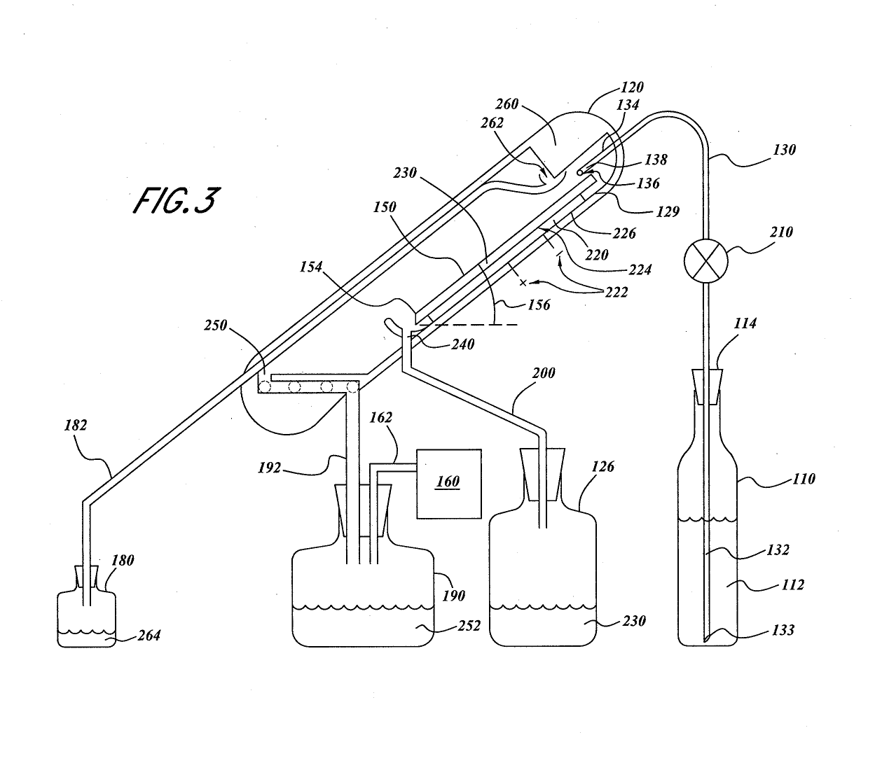

FIG. 3 depicts another example system 100 (e.g., an apparatus) for removing alcohol from an alcoholic liquid (e.g., an alcoholic beverage 112) in accordance with certain embodiments described herein. The beverage 112 can be initially held in a reservoir 110 that is configured to hold the beverage 112. The system 100 comprises a vessel 120 and a fluid conduit 130 (e.g. one or more tubes) configured to be inserted into the beverage 112 and configured to allow the beverage 112 to flow into the vessel 120. The system 100 further comprises a heating system 140 comprising a distribution surface 150 within the vessel 120, wherein the distribution surface 150 is configured to receive the beverage 112 and to heat the beverage 112. The system 100 further comprises a vacuum system 160 configured to apply a vacuum to the beverage 112 while the beverage 112 is heated by the distribution surface 150.

In certain embodiments, the system 100 further comprises a volatiles collection reservoir 180 in fluidic communication with the vessel 120, an alcohol collection reservoir 190 in fluidic communication with the vessel 120, and a collection reservoir 126 in fluidic communication with the vessel 120. For example, the volatiles collection reservoir 180 can be connected to the vessel 120 by a volatiles fluid conduit 182, the alcohol collection reservoir 190 can be connected to the vessel 120 by an alcohol fluid conduit 192, and the collection reservoir 126 can be connected to the vessel 120 by a collection fluid conduit 200. In certain embodiments, one or more of the volatiles fluid conduit 182, the alcohol fluid conduit 192, and the collection fluid conduit 200 are reversibly and repeatedly attachable to the vessel 120. Examples of reservoirs that are compatible for use as the volatiles collection reservoir 180 or the alcohol collection reservoir 190 include but are not limited to chambers, beakers, bottles, tanks, containers) configured to contain the corresponding liquid. One or more of the volatiles collection reservoir 180, the alcohol collection reservoir 190, and the collection reservoir 126 can comprise food safe plastic, glass, stainless steel, or another suitable material for containing the corresponding liquid and holding a reduced pressure (e.g., vacuum) relative to the surrounding environment.

In certain embodiments, at least a portion of the volatiles collection reservoir 180, the alcohol collection reservoir 190, and/or the collection reservoir 126 is cooled to prevent further evaporation of the fluids residing therein. For example, the volatiles collection reservoir 180, the alcohol collection reservoir 190, and/or the collection reservoir 126 can be cooled using refrigeration, thermoelectric elements, a cold material (e.g., ice), or coolant flowing through a cooling jacket. In certain embodiments, the vessel 120, the collection reservoir 126, the volatiles collection reservoir 180, and the alcohol collection reservoir 190 are unitary with one another (e.g., are non-releasably coupled to one another). In some embodiments, the vessel 120, the collection reservoir 126, the volatiles collection reservoir 180, and the alcohol collection reservoir 190 are fully separable and releasably and repeatibly coupled to one another, for example as shown in FIG. 3, by conduits (e.g., tubing). In certain embodiments, at least one of the collection reservoir 126, the volatiles collection reservoir 180, and the alcohol collection reservoir 190 comprises a float switch configured to allow monitoring of the amount of liquid collected in the corresponding reservoir for process control.

In certain embodiments, the volatiles collection reservoir 180, the alcohol collection reservoir 190, and the collection reservoir 126 are located within and/or are part of the vessel 120 as side-chambers (e.g., collection pockets). In certain embodiments, the volatiles vapor is collected in a first collection pocket, the alcoholic vapor is condensed in a second collection pocket, and the reduced-alcohol beverage is collected in a third collection pocket. In certain embodiments, one or more of the collection pockets can be individually cooled to prevent re-evaporation of the liquid contents from the collection pockets. In certain embodiments, one or more of the collection pockets have a male connector that allows them to slide into place within a female connector residing in the vessel 120. In certain embodiments, one or more of the collection pockets are part of the vessel 120.

In certain embodiments, the vacuum system 160 is in fluidic communication with at least one of the volatiles collection reservoir 180, the alcohol collection reservoir 190, and the collection reservoir 126. For example, as schematically illustrated by FIG. 3, the vacuum system 160 is connected to the alcohol collection reservoir 190 (via the vacuum conduit 162) such that the vacuum system 160 is in fluidic communication with the vessel 120. In certain embodiments, as vapors from the beverage 112 on the distribution surface 150 condense on the inside walls 129 of the vessel 120, a portion of the vapor will not contact the walls 129 and will not condense and will be drawn into the vacuum system 160. In certain such embodiments, the vacuum system 160 can comprise a matrix of channels placed in the path of the vapor going to the vacuum pump 162 to further cause those vapors to condense and to drain to a condensate container (e.g., the alcohol collection reservoir 190 shown in FIG. 3 in which these vapors and the condensate are collected together).

In certain embodiments, the system 100 further comprises a selector valve 210 (e.g., a fixed or adjustable metering valve) in fluidic communication with the fluid inlet 132 of the fluid conduit 130 and the portion of the fluid conduit 130 in fluidic communication with the vessel 120. In certain embodiments, the selector valve 210 is controlled electronically and can independently control the amount and flow rate of the beverage 112 that flows from the reservoir 110 into the vessel 120 (e.g., by controllably opening and closing or adjustably metering the fluidic communication between the vessel 120 and the reservoir 110).

In certain embodiments, the heating system 140 comprises a thermoelectric assembly 220 and a plate 230 in thermal communication with the thermoelectric assembly 220. The thermoelectric assembly 220 is in thermal communication with the plate 230 and in thermal communication with an inner surface 129 of the vessel 120. The thermoelectric assembly 220 comprises electrical connectors 222 configured to allow electrical power to be applied to the thermoelectric assembly 220, a first side 224 configured to provide heat to the plate 230 upon electrical power being applied to the thermoelectric assembly 220, and a second side 226 configured to absorb heat from the inner surface 129 upon electrical power being applied to the thermoelectric assembly 220. In this way, the thermoelectric assembly 220 can be operated to heat the plate 230 and to cool the inner surface 129 of the vessel 120. In certain embodiments, the heating system 140 can comprise thermal insulation configured to thermally isolate the heated portions of the thermoelectric assembly 220 from the vessel 120 or other components that are configured to be cooled during operation. In certain embodiments, the heating system 140 can comprise one or more seals (e.g., one or more O-rings) configured to isolate the thermoelectric elements within the thermoelectric assembly 220 from exposure to the gases and liquids within the vessel 120.

In certain embodiments, the heating system 140 further comprises one or more temperature sensors (e.g., thermocouples) configured to monitor temperature of portions of the plate 230 and the distribution surface 150. For example, when there is no more flow of the beverage 112 along the distribution surface 150, the temperature of the plate 230 can rise above the continuous processing temperature (e.g., above the boiling temperature of the beverage 112). The one or more temperature sensors can be operatively coupled to the process control system (e.g., a microprocessor) which is configured to respond to the signals received from the one or more temperature sensors (e.g., by determining the end of the process and starting a shut-down procedure by shutting off components such as the vacuum system 160 and the thermoelectric assembly 220 upon detection of a predetermined temperature indicating that flow has ended).

The plate 230 can comprise the distribution surface 150 and a back surface 232 (e.g., opposite to the distribution surface 150) which is in thermal communication with the first side 224 of the thermoelectric assembly 220. The plate 230 is sufficiently thermally conductive such that heat from the thermoelectric assembly 220 heats the distribution surface 150. The thermoelectric assembly 220 can be configured to heat the distribution surface 150 and cool the inner surface 129 of the vessel simultaneously, such that distillation on the distribution surface 150 and condensation of alcohol vapor on the inner surface 129 occur concurrently.

The beverage 112 can flow along a heated portion of the distribution surface 150 while alcohol and volatiles vaporize from the beverage 112. The remaining portion 230 of the beverage 112 flowing from the distribution surface 150 can be received by a port 240 in fluidic communication with the collection fluid conduit 200, such that the portion 230 of the beverage 112 flows into and is collected by the collection reservoir 126. In certain embodiments, after leaving the distribution plate 150, the portion 230 of the beverage 112 can be cooled in the collection reservoir 126 by cooling at least a portion of the collection reservoir 126 or can be cooled prior to entering the port 240 (e.g., so as to cool the beverage 112 as soon as possible). In certain embodiments, it may be desirable to monitor fluid temperature of the beverage 112 by having the beverage 112 flow along a gutter or channel that is thermally isolated from the distribution surface 150 between the lower portion 154 of the distribution surface 150 and the port 240, and having a temperature sensor (e.g., thermocouple) to measure the temperature of the beverage 112 in the thermally isolated gutter or channel.

In certain embodiments (for example, in configurations where a portion 230 of the reduced alcohol beverage 112 is collected in a separate and/or detachable collection reservoir 126 that is connected to the vessel 120 by a collection fluid conduit 200), the reduced alcohol beverage 112 cools during transit in the collection fluid conduit 200. This cooling is beneficial because the portion 230 of the beverage 112 is cold by the time it reaches the collection reservoir 126. Thus, exposure to oxygen at elevated temperature is avoided. Additionally, re-evaporation of the beverage 112 is avoided because the reduced alcohol beverage 112 is no longer hot enough to evaporate. Further, the collected portion 230 of the reduced alcohol beverage 112 can be consumed or stored immediately after processing (e.g., without additional cooling). In certain embodiments, the collection fluid conduit 200 can itself be cooled using refrigeration, other thermoelectric elements, a cold material or coolant flowing through a cooling jacket.

In certain embodiments, condensation of alcoholic vapors or volatile vapors is accomplished by cooling at least a portion of the vessel 120. For example, as schematically illustrated by FIG. 3, the resulting alcohol vapor can condense on the cooled inner surface 129 of the vessel 120 and can be received by a port 250 in fluidic communication with the alcohol fluid conduit 192, such that the condensed alcohol 252 flows into and is collected by the alcohol collection reservoir 190. In certain embodiments, the port 250 can comprise a serpentine channel through which alcohol vapor flows to facilitate further condensation.

In addition, the resulting volatiles (e.g., volatile substances having a vapor pressure higher than ethanol) can condense on a volatiles condenser 260 (e.g., a cooled portion 260 of the vessel 120 such as a portion of the cooled inner surface 129, or using refrigeration, other thermoelectric elements, a cold material or coolant flowing through a cooling jacket) and can be received by a port 262 in fluidic communication with the volatiles collection reservoir 180, such that the condensed volatiles 264 flows into and is collected by the volatiles collection reservoir 180. In certain embodiments, the port 262 is positioned in proximity to the volatiles condenser 260, such that the condensed volatiles 264 flow through the volatiles fluid conduit 182 to the volatiles collection reservoir 180.

In certain embodiments, as schematically illustrated by FIG. 3, the vessel 120 can be sized to be only slightly larger than the plate 230 that comprises the distribution surface 150. Such a configuration advantageously reduces the amount of heat space within the vessel 120. Such a reduction of the volume to be placed under reduced pressure allows for use of a vacuum system 160 with less pumping speed and/or less pumping capacity. In certain embodiments, a smaller vessel 120 utilizes less heating and cooling capacity. In certain embodiments, the smaller vessel 120 is advantageous because it is lower cost to produce. In certain embodiments, a smaller vessel 120 is also more attractive to the user and easier to store when the system is not in use.

In certain embodiments, depending on the nature of the alcohol water solution (e.g., beverage 112), it might be desirable to conduct the process of reducing the alcoholic content without significantly modifying the flavor, color, and odor of the original solution. Therefore, it is generally desirable to not expose the beverage 112 to too much heat or vacuum for too long a time. In certain embodiments, by holding the temperature of the beverage to 60° C. or below and not allowing the beverage to be exposed to 21″ Hg or less of pressure for more than 20 minutes, the flavor profile of the beverage 112 can be substantially preserved. By using a thin layer flow technique on a heated distribution surface 150 in a vessel 120 under vacuum, certain embodiments advantageously reduce the time of exposure of the beverage 112 to these conditions to a minimum as compared to other systems or processes whereby all or a large portion of the volume of alcohol water solution to be processed is heated all at once.

In certain embodiments, the alcohol removal from the beverage 112 can be monitored, either passively or actively. Passive monitoring can be used by selecting a particular temperature, a particular partial pressure, a particular flow rate, and/or a particular time at the outset for alcohol removal. While using passive monitoring, extra time can be used in the process to ensure the alcohol is removed from the beverage 112. In certain embodiments, other forms of monitoring can be used, such as monitoring the physical liquid level and approximating the amount of alcohol evaporation by the drop of the liquid level. In certain embodiments, chemically monitoring the evaporated vapor, the collected distillate, or the contents of the distillation flasks (e.g., the alcohol collections reservoir 190) can be used. When the alcohol level reaches a target level, the process can be terminated.

As a result of the heat and the vacuum inside the vessel 120, the alcohol from the beverage 112 evaporates. Because the alcohol in the solution has a higher vapor pressure than the water, the alcohol is preferentially evaporated. As the alcohol in the beverage 112 continues to evaporate, the alcohol content of beverage 112 is reduced. Depending on the temperature of the distribution surface 150, the flow rate of the beverage 112 along the distribution surface 150, and the vacuum partial pressure in the vessel 120, the percentage of alcohol within the resulting beverage 112 collected in the collection reservoir 126 can be controlled (e.g., a small reduction of the original concentration to no alcohol remaining).

In certain embodiments, it is undesirable to expose the beverage 112 (e.g., the initial alcoholic beverage, the finished dealcoholized beverage, or the beverage 112 during processing) to oxygen at elevated temperature (e.g., above ambient temperature) since oxygen may cause flavor degradation. In certain embodiments, oxygen is removed from the system 100 using the vacuum system 160. In certain embodiments, a nitrogen source is used to purge oxygen from the system 100 prior to heating the beverage 112. In certain embodiments, after the oxygen is purged, the system 100 is thereafter closed (e.g., sealed) from the surrounding ambient environment. In certain embodiments, immediately after the alcohol is removed, the beverage 112 is still at an elevated temperature, so the beverage 112 is first cooled (e.g., to room temperature) before it is exposed to the atmosphere or to oxygen. In certain embodiments, the heating system 140 is configured to be quickly cooled after processing such that the heating system 140 does not itself store too much heat. In certain embodiments, a cooling system can be used to cool the reduced-alcohol beverage 112, the system 100, or both. In certain embodiments, it is also possible to cool the reduced alcohol beverage 112 by use of a cooling element such as a thermoelectric cooler. When the solution is sufficiently cool, such as 40° C., so that it would not oxidize in atmosphere, the atmosphere can be released into the vessel 120 and the thermoelectric source power can be turned off. When the vessel 120 is up to atmosphere pressure, a port in the bottom of the vessel 120 can be opened (e.g., by removing a plug) and the condensate can be drained.

There are many other features possible but not shown, such as container venting or pressurization to return the vessel 120 to atmospheric pressure once the process is complete, a pump to recirculate the beverage 112 from the lower portion 154 of the distribution surface 150 back to the upper portion 152 of the distribution surface 150, process monitoring devices, process controls as well as other arrangement differences (e.g., having a beaker be the vacuum vessel).

For instance, in certain embodiments, the selector valve can be connected to a computer control system to control (e.g., automatically) the various components of the system to achieve a specific flow rate of alcoholic beverage or a specific amount of vacuum to be pulled on the alcoholic beverage during the distillation process. Furthermore, one or more vacuum gauges or sensors and one or more temperature gauges or sensors can be added to the system to provide measurements which the control system is responsive to in controlling the operation of the various other components of the system. For example, the system can comprise at least one sensor configured to monitor a temperature of the beverage, of an alcohol vapor released from the beverage, or both. In addition, a controllable bleeder valve responsive to control signals from the control system can be added to the system. Alcohol vapor and water vapor monitoring systems can be used. By instrumentation or by time/energy characterization, certain embodiments advantageously reproducibly produce a reduced alcohol beverage with a good flavor profile in a minimum time.

In certain embodiments, the evaporation rate of alcohol can be increased (e.g., maximized) and/or the evaporation of water and/or of any flavor components (especially volatile flavor components) that are contained in a beverage 112 can be decreased (e.g., minimized). In certain embodiments described herein, temperature, flow rate, distribution surface size, vacuum level and time (e.g., at elevated temperature and/or reduced pressure), can be controlled to maximize the amount of alcohol removed from the beverage 112 and to minimize the amount of volatiles flavor components and water removed. The following describes temperatures and vacuum levels that can be used maximize alcohol removal and minimize water and flavor component removal. The volatiles are more volatile than the alcohol within the beverage. Consequently, in certain embodiments, the volatiles (e.g., volatile flavor components) will evaporate prior to the alcohol within the beverage (and also before the water). To address the loss of volatiles, a condensation area can be used to preferentially catch the first evaporation at the top end of the distribution surface 150. Once volatiles are collected (e.g., for reconstituting the reduced-alcohol beverage 112), the temperature, flow rate, vacuum level, and time can be adjusted to optimize alcohol removal from the beverage 112.

In certain embodiments, it is desirable to reduce process time (e.g., to improve the flavor of the beverage 112, to minimize the waiting time for the beverage 112, etc.) by elevating the temperature of the beverage 112. Further, thermal control of the process may be complicated by different fluids having unique latent heats of vaporization. That is, it may take thermal energy to transform a liquid to a vapor state—even when the liquid is at its boiling point. If insufficient heat is supplied to the liquid, this heat energy for vaporization will be extracted from the fluid (e.g., beverage 112), cooling it. This cooling will continue until the evaporation ceases and the process stalls. In certain embodiments, to maintain a continuous useful rate of evaporation of the solution, the solution is heated by the distribution surface 150 to provide sufficient heat to the beverage 112 to bring the beverage 112 to the boiling temperature and to vaporize the alcohol and other evaporates (e.g., such that the latent heat for vaporization is provided by the distribution surface 150 and not the beverage 112). In certain embodiments, the only heat source is the heat source of the distribution surface 150. In certain embodiments, the latent heat of vaporization is returned to the vessel walls when the vapor condenses on the inside of the vessel 120 walls, which would warm the walls if the walls were not cooled by the thermoelectric device and the heat is returned to the distribution surface 150.

In certain embodiments, temperature can be predetermined by the amount of heat applied to the beverage 112 for a specific time. In certain embodiments, the heat power and time can be predetermined to provide the proper temperature profile. In certain embodiments, a temperature monitoring and controlling device can be used. In certain embodiments, the temperature of the vessel 120 is maintained at a temperature within the range from about 1° C. to about 10° C., from about 10° C. to about 20° C., from about 20° C. to about 30° C., from about 30° C. to about 40° C., from about 40° C. to about 50° C., from about 50° C. to about 60° C., from about 60° C. to about 70° C., or from about 70° C. to about 80° C. In certain embodiments, the temperature of the distilling vapor is at a temperature within the range from about 1° C. to about 10° C., from about 10° C. to about 20° C., from about 20° C. to about 30° C., from about 30° C. to about 40° C., from about 40° C. to about 50° C., from about 50° C. to about 60° C., from about 60° C. to about 70° C., or from about 70° C. to about 80° C. In certain embodiments, the beverage 112 is not subjected to a temperature exceeding 70° C.

In certain embodiments, minimizing the time that the beverage 112 is exposed to temperature also preserves the flavor of the final reduced beverage 112. In certain embodiments, the beverage 112 being treated is exposed to an elevated temperature for a period of time ranging from about 5 to about 10 minutes, from about 10 minutes to about 20 minutes, from about 20 minutes to about 40 minutes, from about 40 minutes to about 60 minutes, from about 60 minutes to about 90 minutes, from about 90 minutes to about 120 minutes, from about 120 minutes to about 180 minutes (e.g., 3 hours), from about 3 hours to about 4 hours, or from about 4 hours to about 5 hours. In certain embodiments, the beverage 112 being treated is exposed to an elevated temperature for a period of time ranging from about 45 minutes to about 90 minutes.

In certain embodiments, it is desirable to reduce process time (e.g., to improve the flavor of the beverage 112, to minimize the waiting time for the beverage 112, etc.) by reducing the pressure in the vessel 120 during distillation. In certain embodiments, the vacuum level can be predetermined and held to proper limits by design of the vacuum system 160. In certain embodiments, the vacuum level can be actively monitored and controlled within proper process limits by a microprocessor or other control methods. In certain embodiments, the process time can be simply controlled by a timing device to keep vacuum times, heat times, and cooling times within predetermined limits. In certain embodiments, a vacuum is applied to the system 100 such that the pressure within the vessel 120 is controlled to range between about 0.5″ Hg and about 1.5″ Hg, between about 1.5″ Hg and about 2.5″ Hg, between about 2.5″ Hg and about 4.5″ Hg, between about 4.5″ Hg and about 6.5″ Hg, between about 6.5″ Hg and about 8.5″ Hg, between about 8.5″ Hg and about 10.5″ Hg, between about 10.5″ Hg and about 11.5″ Hg, between about 10.5″ Hg and about 12.5″ Hg, between about 12.5″ Hg and about 14.5″ Hg, between about 14.5″ Hg and about 16.5″ Hg, between about 16.5″ Hg and about 18.5″ Hg, between about 18.5″ Hg and about 20.5″ Hg, between about 20.5″ Hg and about 22.5″ Hg, between about 22.5″ Hg and about 24.5″ Hg, between about 24.5″ Hg and about 26.5″ Hg, between about 26.5″ Hg and about 28.5″ Hg, or between about 28.5″ Hg and about 30.0″ during alcohol removal. In certain embodiments, a vacuum is applied to the system 100 such that the pressure within the vessel 120 is controlled to range between about 21″ Hg and about 29″ Hg.

To produce and maintain the vacuum levels described herein, certain embodiments comprise vacuum tight seals between separate components. For example, in certain embodiments, when the vessel 120 comprises glass, vacuum tubing (e.g. rubber) can be used as the fluid conduit. In certain embodiments, where the vessel 120 and the fluid conduit 130 both comprise glass, grounded glass connectors can be used to secure the vessel 120 to the fluid conduit 130 with a small amount of vacuum grease to form a vacuum tight seal. In certain embodiments, where the vessel 120 and/or the fluid conduit 130 comprise metal (e.g., stainless steel), o-rings (e.g. rubber) may be employed between the connections to achieve air tight seals. Other methods known in the art for achieving air tight seals may also be employed.

In certain embodiments described herein, it is also desired to complete the process as quickly as possible so that the user has access to a drink with lower alcohol content within a convenient time frame for an individual use. In certain embodiments, the time it takes to process a beverage 112 (e.g., one, two, three, or more servings, or a whole bottle) so that it contains a lower volume of alcohol is in the range from about 1 minute to about 10 minutes. In certain other embodiments, the time it takes to process a predetermined quantity of the beverage 112 so that it contains a lower volume of alcohol is in the range from about 10 minutes to about 20 minutes, from about 20 minutes to about 40 minutes, from about 40 minutes to about 60 minutes, from about 60 minutes to about 90 minutes, from about 90 minutes to about 120 minutes, from about 120 minutes to about 180 minutes (e.g. 3 hours), from about 3 hours to about 4 hours, or from about 4 hours to about 5 hours. In certain embodiments the distillation time ranges from about 40 to 90 minutes.

After processing, the alcohol content of the reduced alcohol beverage is reduced relative to the initial alcoholic beverage. In certain embodiments, the alcohol content remaining in the reduced alcohol beverage is in a range from about from about 30% to about 20%, from about 20% to about 10%, from about 10% to about 9%, from about 9% to about 8%, from about 8% to about 7%, from about 7% to about 6%, from about 6% to about 5%, from about 5% to about 4%, from about 4% to about 3%, from about 3% to about 2%, from about 2% to about 1%, from about 1% to about 0.5%, or below 0.5%. In certain embodiments, the alcohol content remaining in reduced alcohol wine or rice wine is in a range from about 10% to about 6%, from about 6% to about 4%, from about 4% to about 2%, from about 2% to about 0.5%, or below about 0.5% (which is the level recognized as “non-alcoholic”). In certain embodiments, the alcohol content remaining in the reduced alcohol beer is in a range from about 10% to about 6%, from about 6% to about 4%, from about 4% to about 2%, from about 2% to about 0.5%, or below about 0.5%. In certain embodiments, the alcohol content remaining in the reduced alcohol liquor is in the range from about 30% to about 20%, from about 20% to about 10%, from about 10% to about 6%, from about 6% to about 4%, from about 4% to about 2%, from about 2% to about 0.5%, or below about 0.5%.

In certain embodiments, the concentration of alcohol in the condensed vapor or distillate will generally be higher than the % alcohol concentration in the original alcoholic beverage. In certain embodiments, the % of alcohol remaining in the reduced alcohol beverage will be less than that in the original alcoholic beverage by an amount in the range from between about 5% to about 15%, about 15% to about 25%, about 25% to about 35%, about 35% to about 45%, about 45% to about 55%, about 55% to about 65%, about 65% to about 75%, about 75% to about 85%, about 85% to about 95%, and/or about 95% to about 100%.

In certain embodiments described herein, water will also be removed with the alcohol and the volume of the beverage 112 collected in the collection reservoir 126 or returned to the original reservoir 110 will be reduced by the evaporated alcohol and water. In certain embodiments, the user can choose to reconstitute the collected solution with water or to use it in the collected state. For example, the beverage 112 (e.g. wine) can be reconstituted to its original flavor, water, and/or total volume profile by the addition of pure water. In certain embodiments, the amount of water added will be in a volume sufficient to replace the water removed during processing. In certain embodiments, where the alcoholic beverage 112 was initially carbonated, the beverage 112 can be re-carbonated after dealcoholization. In certain embodiments, any volatile flavor components that were removed during the dealcoholization process are added back to the reduced alcohol beverage 112. In certain embodiments, the beverage 112 to be processed is transferred to a graduated reservoir 110 so that the amount of liquid removed from the graduated reservoir 110 can be calculated. In certain embodiments, the reduced alcohol beverage can be reconstituted to its original volume using the graduations to calculate the amount of water to be added. In certain embodiments, the volatiles collected in the volatiles collection reservoir 180 added back to the reduced alcohol beverage.

In certain embodiments, because the process does not damage the flavor quality of the beverage 112, the alcohol can be removed and the water can also be removed such that the remaining solution becomes a non-alcohol bearing concentrate of the original solution such that it can be stored for use in a fraction of the original volume and reconstituted at a ratio of more than 2:1 (water to concentrate) for consumption.

### Example 1

The following example gives process parameters that can be selected in the use of the apparatus of FIG. 2. The processing time of 750 ml of wine (wine flowing on the distribution surface 150) can be between 15 and 120 minutes. A vacuum can be applied such that the internal pressure of the vessel 120 is between 16 to 29″ Hg. The wine can be delivered at a rate such that the wine flowing across the distribution surface 150 is in contact with the distribution surface 150 for 2 to 18 seconds (where the distribution surface 150 is plate-shaped having a length of 12″ and a width of 10″, across which the wine is distributed). The wine can be heated using the distribution surface 150 such that while it is in contact with the distribution surface 150, the temperature of the wine is controlled to be between 30° C. and 70° C. The angle of the plate can be controlled to 15 to 60 degrees from horizontal.

### Example 2

The following example gives process parameters that can be selected in the use of the apparatus of FIG. 3. A vacuum can be applied such that the internal pressure of the vessel 120 is between 16 to 29″ Hg. The processing time of 750 ml of wine (wine flowing on the distribution surface) can be between 15 and 120 minutes. The wine can be delivered at a rate such that the wine is in contact with the distribution surface 150 for 2 to 18 seconds. The wine can be heated using the distribution surface 150 such that while it is in contact with the distribution surface 150, the temperature of the wine is controlled to be between 30° C. and 60° C. The angle of the plate can be controlled to 45 degrees from horizontal.

Various embodiments have been described above. Although this invention has been described with reference to these specific embodiments, the descriptions are intended to be illustrative of the invention and are not intended to be limiting. Various modifications and applications may occur to those skilled in the art without departing from the true spirit and scope of the invention as described herein.

What is claimed is:

1. An apparatus for removing alcohol from alcoholic beverages, the apparatus comprising:
a vessel;
a fluid conduit configured to be inserted into a beverage, the fluid conduit configured to allow the beverage to flow into the vessel;
a heating system comprising a distribution surface within the vessel, the distribution surface configured to receive the beverage and to heat the beverage; and
a vacuum system configured to apply a vacuum to the beverage while the beverage is heated by the distribution surface.

2. The apparatus of claim 1, wherein the heating system comprises a plurality of thermoelectric elements configured to heat the distribution surface in response to an electric current.

3. The apparatus of claim 1, further comprising a reservoir configured to contain the beverage, wherein the reservoir is in fluid communication with the vessel via the fluid conduit.

4. The apparatus of claim 3, wherein the fluid conduit is configured to allow vacuum to pull the beverage from the reservoir into the vessel.

5. The apparatus of claim 3, wherein the fluid conduit is configured to be attached to and reversibly detached from the reservoir.

6. The apparatus of claim 1, wherein the heating system comprises a plate which comprises the distribution surface.

7. The apparatus of claim 1, wherein the heating system comprises a thermoelectric assembly and electrical connectors configured to allow electrical power to be applied to the thermoelectric assembly, wherein a first side of the thermoelectric assembly is configured to provide heat to the distribution surface upon electrical power being applied to the thermoelectric assembly, and a second side of the thermoelectric assembly configured to absorb heat from an inner surface of the vessel upon electrical power being applied to the thermoelectric assembly.

8. The apparatus of claim 1, further comprising at least one port to deliver the beverage received from the fluid conduit to a portion of the distribution surface.

9. The apparatus of claim 8, wherein the at least one port is configured to disperse the beverage as a thin flow onto the distribution surface.

10. The apparatus of claim 1, wherein the fluid conduit is perforated along a length in proximity to the distribution surface to allow the beverage to be received by the distribution surface.

11. The apparatus of claim 1, wherein, during operation, the distribution surface has an upper portion and a lower portion, wherein the beverage is received by the upper portion, wherein the distribution surface is configured such that the beverage is heated as the beverage travels from the upper portion to the lower portion of the distribution surface.

12. The apparatus of claim 11, wherein the beverage reaching the lower portion of the distribution surface is collected in a collection reservoir.

13. The apparatus of claim 12, wherein at least a portion of the collection reservoir is cooled.

14. The apparatus of claim 12, further comprising:
a reservoir configured to contain the beverage, wherein the reservoir is in fluid communication with the vessel via the fluid conduit;
a recycling conduit, wherein the recycling conduit is in fluid communication with the reservoir and the collection reservoir such that the contents of the collection reservoir can be transferred to the reservoir via the recycling conduit.

15. The apparatus of claim 1, wherein the distribution surface comprises one or more structures selected from the group consisting of: ridges, channels, troughs, conduits, indentations, protrusions, perforations, and additive layers.

16. The apparatus of claim 1, wherein the distribution surface comprises at least one of a metallic mesh layer and a paper layer.

17. The apparatus of claim 1, wherein the apparatus further comprises an alcohol collection reservoir.

18. The apparatus of claim 17, wherein at least a portion of the vessel is in thermal communication with a cooling source that allows alcohol-containing distillate from the beverage to condense and flow to the alcohol collection reservoir.

19. The apparatus of claim 17, wherein at least a portion of the vessel contains ice wherein the alcohol-containing distillate on the interior walls of the vessel flows into the ice thereby diluting the alcohol-containing distillate.

20. The apparatus of claim 1, wherein the apparatus further comprises a volatiles collection reservoir.

21. The apparatus of claim 20, wherein at least a portion of the vessel is in thermal communication with a cooling source that allows volatiles from the beverage to condense and flow to the volatiles collection reservoir.

22. The apparatus of claim 1, wherein the vacuum source is controllable to apply a vacuum to the beverage wherein the pressure is controlled to between about 10.5″ Hg and about 11.5″ Hg, between about 10.5″ Hg and about 12.5″ Hg, between about 12.5″ Hg and about 14.5″ Hg, between about 14.5″ Hg and about 16.5″ Hg, between about 16.5″ Hg and about 18.5″ Hg, between about 18.5″ Hg and about 20.5″ Hg, between about 20.5″ Hg and about 22.5″ Hg, between about 22.5″ Hg and about 24.5″ Hg, between about 24.5″ Hg and about 26.5″ Hg, between about 26.5″ Hg and about 28.5″ Hg, or to between about 28.5″ Hg and about 30.0″ Hg.

23. The apparatus of claim 1, wherein the apparatus further comprises at least one sensor configured to monitor a temperature of the heated distribution surface, the beverage, or both.

24. The apparatus of claim 1, wherein the vessel is graduated.

25. The apparatus of claim 1, wherein the vacuum system comprises a vacuum pump and further comprises a matrix of chilled channels placed in a path of at least one of alcohol vapor and water vapor going to the vacuum pump, wherein the matrix of channels condenses the at least one alcohol vapor and water vapor.

26. An apparatus for removing alcohol from alcoholic beverages, the apparatus comprising:
a vessel;
a fluid conduit configured to be inserted into a beverage, the fluid conduit configured to allow the beverage to flow into the vessel;
a distribution surface configured to receive the beverage and to be in thermal communication with the beverage;
a heating element configured to heat the distribution surface; and
a vacuum system configured to apply a vacuum to the beverage received by the distribution surface.

27. The apparatus of claim 26, wherein the distribution surface is cone-shaped, sheet-shaped, plate-shaped, fluted, ribbed, or channeled.

28. A method for reducing the alcohol content of a beverage, the method comprising:
flowing the beverage along a portion of a distribution surface of a heating plate;
applying heat to the beverage while the beverage flows along the portion of the distribution surface;
applying vacuum to the beverage while the beverage flows along the portion of the distribution surface; and
collecting the beverage after having flowed along the portion of the distribution surface.

29. The method of claim 28, wherein the alcohol content of the collected beverage is in the range between about 0.01% to about 1%, about 1% to about 3%, from about 3% to about 5%, from about 5% to about 10%, or from about 10% to about 15%.

30. The method of claim 28, wherein the beverage has a first volume prior to flowing along the portion of the distribution surface, the method further comprising reconstituting the collected beverage to the original volume by adding water to the collected beverage.

31. The method of claim 28, further comprising cooling the collected beverage to less than 50° C. before the collected beverage is exposed to oxygen.

32. The method of claim 28, wherein applying heat to the beverage comprises heating the beverage to less than 60° C.

33. The method of claim 28, wherein applying vacuum to the beverage comprises applying a pressure between about 21″ Hg and about 29″ Hg to the beverage.
